(19) United States
(12) Patent Application Publication
(10) Pub. No.: US 2012/0228321 A1
(43) Pub. Date: Sep. 13, 2012

(54) DEVICE FOR COUNTING OBJECTS FED AS BULK MATERIAL

(75) Inventor: Dieter Heinz, Nuernberg (DE)

(73) Assignee: FRITZ COLLISCHAN GMBH & CO. KG, Nuernberg (DE)

(21) Appl. No.: 13/508,869

(22) PCT Filed: Nov. 9, 2010
(86) PCT No.: PCT/EP2010/067146

§ 371 Date: May 9, 2012

(30) Foreign Application Priority Data
Nov. 9, 2009 (DE) 10 2009 052 292.1

(51) Int. Cl. B65G 43/00; B65G 27/00

(52) U.S. Cl. 221/9

(57) ABSTRACT

The invention relates to a device for counting objects fed as bulk material, comprising a first feeding unit for pre-counting a first fixed subset of a target quantity of objects and a second feeding unit for preferably separately feeding a second subset of the target quantity of objects, wherein the device (1, 7, 10) is designed such that the quantity of objects of the first subset is transmitted to a control apparatus (5), which controls the second feeding unit such that the second subset of objects is fed enough objects that the second subset of objects corresponds to the difference between the first subset and the target quantity of objects, and the first subset of objects is poured into the second subset of objects.

The invention relates to an apparatus for counting objects fed as bulk material, having a first feeding device for the preliminary counting of a first defined sub-quantity of a desired number of objects, and having a second feeding device for the preferably separate feeding of a second sub-quantity of the desired number of objects.

Apparatuses which are intended for counting objects fed as bulk material and which can count products such as tablets, pellets, certain foodstuffs or electronic components, so that a precisely defined number of products can then be processed further or packaged, are already known. In the case of such counting apparatuses, the objects pass from a filling hopper into conveying channels which are arranged parallel to one another and are closed gradually during the metering operation.

Other apparatuses, in which metering is controlled by weight, are also known. Since the mass of the individual objects is usually subject to fluctuation, the overall weight sensed can be used to draw only approximate conclusions in respect of the precise number of objects. In certain cases, however, it is necessary to determine the precise number of objects, which is not possible with conventional apparatuses, on account of the weight-controlled metering.

It is therefore an object of the invention to specify an apparatus which is intended for counting objects fed as bulk material and which can count a defined desired number of objects quickly and precisely.

This object is achieved by an apparatus of the type mentioned in the introduction, which is designed such that the number of objects in the first sub-quantity is communicated to a control device, which controls the second feeding device such that the second sub-quantity of objects is fed as many objects as are necessary in order for the second sub-quantity of objects to correspond to the difference between the first sub-quantity and the desired number of objects, and the first sub-quantity of objects is poured into the second sub-quantity of objects.

The invention is based on the concept of the metering of objects which are present in the form of bulk material taking place not in dependence on the weight sensed, but instead with reference to the individual objects counted, so that it is ensured that the defined desired number of objects is observed precisely. For this purpose, the preliminary counting of a first defined sub-quantity of the desired number of objects takes place via a first feeding device, wherein the precise number of objects is sensed. The second feeding device is then controlled such that it feeds as many objects as are necessary in order for the second sub-quantity of objects to correspond to the difference between the first sub-quantity and the desired number of objects. The operations of conveying and counting the second sub-quantity of objects take place more slowly than in the case of the first sub-quantity since they have to be carried out with a high degree of precision, in order that the defined desired quantity of objects is not exceeded.

According to the invention, it may be provided that the apparatus has a container into which the first sub-quantity of the desired number of objects is poured following the preliminary counting. This container serves as an interim store, in which the objects counted are collected until the second sub-quantity of objects has been counted.

A particularly advantageous development of the apparatus according to the invention provides that, during the feeding of the second sub-quantity of the desired number of objects, the control device controls the preliminary counting of the first sub-quantity for the next counting operation. This makes it possible for the second sub-quantity to be fed and counted while, at the same time, the first sub-quantity of objects for the next counting operation is being fed and counted. It is thus possible for the operations of counting the first sub-quantity and the second sub-quantity of objects to overlap in time, or to be carried out in parallel, so that the desired number of objects can be counted more quickly overall.

In the case of the apparatus according to the invention, the first feeding device and/or the second feeding device may be designed as a vibratory conveying path, in particular as a vibratory channel. The bulk material can be conveyed in a controlled manner via this vibratory channel, wherein the quantity and the speed of the bulk material conveyed can be adjusted by means of the control device, via the intensity of vibration. As an alternative, it is possible for the first feeding device and/or the second feeding device to be driven by means of a servomotor.

It is particularly advantageous if, in the case of the apparatus according to the invention, the vibratory conveying path is controlled or regulated by the control device, with reference to the objects counted, such that the speed of the objects fed is reduced as the defined sub-quantity of objects is approached. Accordingly, the objects at the start of a counting operation are fed comparatively quickly via the vibratory conveying path; prior to the desired number for the first sub-quantity and/or second sub-quantity of objects being reached, the conveying speed is reduced, so that this desired number can be observed precisely.

In the case of the apparatus according to the invention, it may be provided that it has a counting module for counting the objects, or a first counting module for counting the first sub-quantity and a second counting module for counting the second sub-quantity of objects, wherein the counting modules are designed preferably for contactless counting of the objects. The counting modules may be positioned downstream of the vibratory channel, so that the objects leave the vibratory channel, and are counted, in free fall. The counting modules are able to sense the number of objects in an extremely precise manner via corresponding sensors, even should one object be concealed wholly or partially by another object.

The counting module used in the case of the apparatus according to the invention can make use of different measuring methods, for example it may be designed for optical and/or electromagnetic and/or capacitive and/or acoustic sensing of the objects.

According to a development of the apparatus according to the invention, it may be provided that the first feeding device has a shutter which is closed when the desired number for the first sub-quantity of objects is reached. In this way, the stream of objects conveyed is interrupted when the first desired number of objects is reached, so that no further objects are fed via the first feeding device. The rest of the objects required are then fed exclusively via the second feeding device.

It is also possible, within the context of the invention, for the first feeding device and the second feeding device to be regulated separately from one another. This means that, when the first sub-quantity of objects is complete, conveying by the first feeding device can be terminated, for example by virtue of the shutter being dosed, whereupon the first feeding device is stopped. The operations of feeding and counting the second sub-quantity of objects then takes place, by merely the second feeding device being driven, This prevents the objects from accumulating upstream of the shutter in the first feeding device, which otherwise would make it more difficult for the individual objects to be counted precisely.

The apparatus according to the invention is preferably designed such that the first feeding device can feed 90 to 95% of the desired number of objects; the difference from the desired number of objects is fed by the second feeding device.

If, in exceptional cases, too many objects have been conveyed, that is to say if the second sub-quantity of objects conveyed and counted is greater than the difference between the first sub-quantity of the desired number of objects and the desired number, it is possible for the second sub-quantity of objects to be rejected, by being poured, for example, into a special container. This is followed by a second sub-quantity of objects being fed and counted once again, so that the desired number of objects is reached precisely. In the case of the apparatus according to the invention, it is thus necessary to reject, if need be, the comparatively small second sub-quantity of objects, but not the larger first sub-quantity of objects. This is particularly advantageous since, in the case of certain applications, separated-out objects must not be re-introduced into the metering operation.

Further advantages and details of the invention will be described by way of exemplary embodiments and with reference to the drawings, in which, schematically:

FIG. 1 shows a first exemplary embodiment of an apparatus according to the invention;

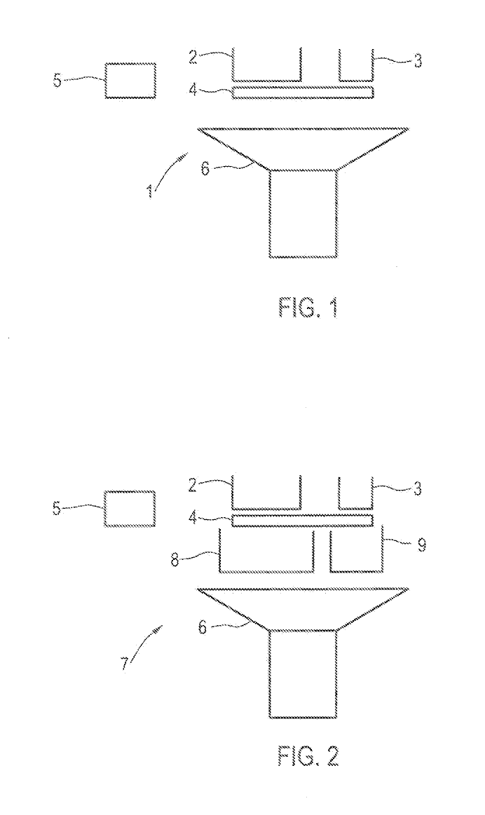

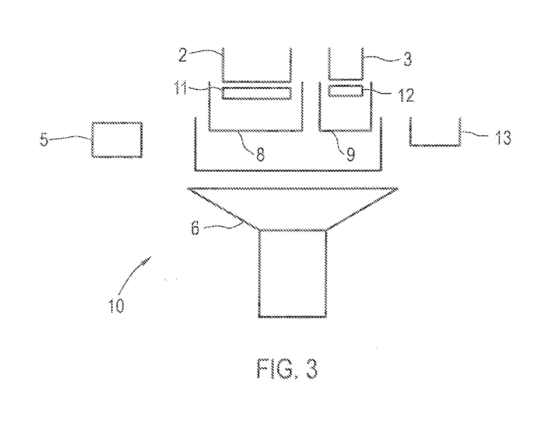

FIG. 2 shows a second exemplary embodiment of an apparatus according to the invention; and

FIG. 3 shows a third exemplary embodiment of an apparatus according to the invention.

The apparatus 1 shown in FIG. 1 comprises a first feeding device for the preliminary counting of a first defined sub-quantity of a desired number of objects fed as bulk material. The objects may be, for example, tablets, capsules, electronic components or pellets. The first feeding device comprises a comparatively wide vibratory channel 2, via which the objects are fed. The vibrations generated cause all the objects to move in the form of a stream along the vibratory channel 2. In addition, the apparatus 1 comprises a second feeding device, for feeding a second sub-quantity of the desired number of objects. The second feeding device comprises a vibratory channel 3, which is designed to be smaller and/or narrower than the first vibratory channel 2. The first feeding device and the second feeding device can be driven separately from one another in each case via drive means, so that, in a certain operating state, one feeding device conveys objects while the other feeding device is at a standstill. The two feeding devices are designed as vibratory conveying paths in the case of which the control or regulation of the vibratory movement makes it possible to adjust the quantity and the speed of the bulk material conveyed.

The apparatus 1 can be used to count a certain desired number, for example 100; of objects, it being possible for this number to be defined in any manner required. This desired number is made up of a first defined sub-quantity, which is fed via the first feeding device, and of a second sub-quantity, which is fed via the second feeding device. In the exemplary embodiment illustrated, the first sub-quantity comprises 95 objects and the second sub-quantity comprises 5 objects. Once the open end of the vibratory channel 2 has been reached, the objects fall downward from the vibratory channel 2. While the objects are in free fall, they are counted by a counting module 4, which is illustrated merely schematically in the drawing. The counting module 4 has sensors which can measure the number of passing objects with a high degree of accuracy, even if the objects are concealing one another wholly or partially. Accordingly, in the exemplary embodiment illustrated, the first feeding device feeds the objects as bulk material until 95 objects have been counted. During the operation of conveying the objects, the vibratory channel 2 is controlled by a schematically illustrated control device such that the speed of the objects fed is reduced as the defined desired-number sub-quantity comprising 95 objects is approached. Any further feeding of objects is prevented by a shutter (not shown in FIG. 1) which doses the vibratory channel 2. This prevents too many objects from being fed accidentally. However, it is possible for the first sub-quantity of objects not to comprise 95 objects precisely; instead, it would also be possible for the counting module 4 to count 93 or 97 objects. The number of objects counted in the first sub-quantity is then communicated to a control device 5, which then controls the second feeding device with the vibratory channel 3 such that the second sub-quantity of objects is fed as many objects as are necessary in order for the second sub-quantity of objects to correspond to the difference between the first sub-quantity and the desired number of objects. If the first sub-quantity comprises 95 objects, five further objects are thus fed via the vibratory channel 3; if the first sub-quantity comprises 97 objects, just three further objects are fed via the vibratory channel 3. The objects free fall from the vibratory channel 3 to the counting module 4, which counts the objects as they pass by. If the sum of the objects in the first sub-quantity and the objects in the second sub-quantity corresponds to the desired number of objects, the objects are supplied, via an outlet hopper 6, for filling purposes, packaging purposes or for further processing steps.

FIG. 2 shows a second exemplary embodiment, having an apparatus 7, wherein corresponding constituent parts have been designated by the same designations as in the first exemplary embodiment, in correspondence with the first exemplary embodiment, the apparatus 7 comprises feeding devices which are designed as vibratory channels 2, 3 and have a counting module 4 positioned downstream of them. The vibratory channels 2, 3 are regulated via the control device 5.

A container 8 is located beneath the vibratory channel 2, so that the objects are collected in the container 8 once they pass by the counting module 4. A container 9 is located beneath the vibratory channel 3, and the objects from the vibratory channel 3 pass into this container once they pass by the counting module 4.

While the second sub-quantity of objects is being counted via the vibratory channel 3 and collected in the container 9, the control device 5, which is connected to the individual components of the apparatus 7 via lines (not illustrated specifically), initiates, and controls, the preliminary counting of the first sub-quantity of objects for the next metering and counting operation, so that the two counting operations overlap in time. Since, at least in certain operating states, objects are fed simultaneously via the vibratory channels 2, 3, the apparatus 7 can be used to count a certain desired number of objects with a high degree of accuracy more quickly than an apparatus which has just one single conveying path.

FIG. 3 shows a third exemplary embodiment of the invention, wherein, once again, corresponding constituent parts have been designated by the same designations as in the previous exemplary embodiments. The apparatus 10 comprises feeding devices designed as vibratory channels 2, 3, wherein the objects fall from the vibratory channel 2 into the container 8 and from the vibratory channel 3 into the container 9. In contrast to the previous exemplary embodiments, each feeding device is assigned a separate counting module. The objects fed by the vibratory channel 2 are sensed by the counting module 11, and the objects fed via the vibratory channel 3 are sensed via the counting module 12. Using two separate counting modules makes it possible to improve accuracy further, since the objects counted can clearly be assigned to the respective feeding device.

In exceptional cases, it may be so that the number of objects in the container 9 does not correspond with the difference between the number of objects in the container 8 and the desired number of objects, for example if 95 objects are located in the container 8 and six objects are located in the container 9. When this error is observed by the control device 5, the contents of the container 9 can be poured into a container 13, as a result of which the objects of the container 9 are separated out. However, the number of objects in the bulk material which have to be separated out when the desired number of objects is exceeded is advantageously small in comparison with the desired number of objects. Once the objects of container 9 have been rejected, and poured into the container 13, the control device 5 initiates a new counting operation, by the emptied container 9 being re-filled with objects via the vibratory channel 3 until the second sub-quantity of objects corresponds to the difference. The container 13 shown in the drawing, however, is optional; as far as extremely precise counting using the counting modules 8, 9 is concerned, embodiments without a container 13 are also possible,

1. An apparatus for counting objects fed as bulk material, comprising:
a first feeding device for the preliminary counting of a first defined sub-quantity of a desired number of objects, and
a second feeding device for separate feeding of a second sub-quantity of the desired number of objects,
wherein the number of objects in the first sub-quantity is communicated to a control device, which controls the second feeding device such that the second sub-quantity of objects is fed as many objects as are necessary in order for the second sub-quantity of objects to correspond to the difference between the first sub-quantity and the desired number of objects, and the first sub-quantity of objects is poured into the second sub-quantity of objects.

2. The apparatus as claimed in claim 1, further comprising a container into which the first sub-quantity of the desired number of objects is poured following the preliminary counting.

3. The apparatus as claimed in claim 2, wherein, during the feeding of the second sub-quantity of the desired number of objects, the control device controls the preliminary counting of the first sub-quantity for the next counting operation.

4. The apparatus as claimed in claim 1, wherein the first feeding device and/or the second feeding device are/is designed as a vibratory conveying path, or the first feeding device and/or the second feeding device are/is driven by means of a servomotor.

5. The apparatus as claimed in claim 4, wherein the vibratory conveying path is controlled or regulated by the control device, with reference to the objects counted, such that the speed of the objects fed is reduced as the defined sub-quantity of objects is approached.

6. The apparatus as claimed in claim 1, further comprising a counting module for counting the objects, or a first counting module for counting the first sub-quantity and a second counting module for counting the second sub-quantity, wherein the counting module or modules is or are designed preferably for contactless counting of the objects.

7. The apparatus as claimed in claim 6, wherein the counting modules are designed for optical and/or electromagnetic and/or capacitive and/or acoustic sensing of the objects.

8. The apparatus as claimed in claim 1, wherein the first feeding device has a shutter which is closed by the control device when the desired number for the first sub-quantity of objects is reached,

9. The apparatus as claimed in claim 1, wherein the first feeding device and the second feeding device can be regulated separately from one another.

10. The apparatus as claimed in claim 1, wherein the first feeding device can feed 90 to 95% of the desired number of objects.
